(19) United States
(12) Patent Application Publication
(10) Pub. No.: US 2012/0251732 A1
(43) Pub. Date: Oct. 4, 2012

(54) Process of Applying Water-based Rubber Copolyer to Textile

(76) Inventors: Ching-Ming Jwo, Kuanyin Hsiang (TW); Chin-Jen Jwo, Kuanyin Hsiang (TW); Shih-Shang Lo, Kuanyin Hsiang (TW); Ying-Tasi Kao, Kuanyin Hsiang (TW)

(21) Appl. No.: 13/074,075

(22) Filed: Mar. 29, 2011

(51) Int. Cl. B05D 1/18

(52) U.S. Cl. 427/430.1

(57) ABSTRACT

A process of making a textile comprising dropping a predetermined amount of rubber copolymer in a reactor filled with a solvent including 90-100 wt % of toluene, 0-10 wt % of acetone, and 0-10 wt % of ethanol; adjusting conditions of the reactor to a predetermined range of temperature and a predetermined atmospheric pressure so as to reduce sizes of molecules of the rubber copolymer; adding water to the reactor to disperse the rubber copolymer in the solvent to make an aqueous solution with dispersing rubber copolymer; and penetrating the water-based rubber copolymer through fibers of the textile for permanently attaching thereto.

### BACKGROUND OF THE INVENTION

1. Field of the Invention

The invention relates to textile manufacturing processes and more particularly to a process of applying a water-based rubber copolymer to a textile so as to produce a textile having fibers permeated with the rubber copolymer.

2. Description of Related Art

There is a kind of textile having yarn permeated with flexible plastic in which the textile is produced by spinning raw fibers of cotton, flax, wool, nylon, polyester, PU (polyurethane), PP (polypropylene), and acrylic. The flexible plastic is plasticized to be smooth as silk (or has not been plasticized). Such textile also has the features of keeping warm and being vibration proof.

There are three known processes of producing the above textile (i.e., textile permeated with plastic) as detailed below. First process involves mixing PU (which is one of the most used materials in producing textile permeated with plastic) with plasticizer to form a paste-like mixture which is in turn applied on a fibrous textile, the mixture and the fibrous textile are subject to high temperature, and finally a textile permeated with plastic is formed due to the curing of the plasticizer.

Second process involves mixing PVC (polyvinyl chloride) (which is one of the most used materials in producing textile permeated with plastic) with plasticizer to form a mixture which is in turn pressed by a pressing machine to form a continuous sheet structure, the sheet structure is next applied on a fibrous textile, the sheet structure and the fibrous textile are subject to high temperature, and finally a textile permeated with plastic is formed due to the curing of the plasticizer.

Third process involves mixing TPU (thermoplastic polyurethane) (which is one of the most used materials in producing textile permeated with plastic) with plasticizer to form a mixture, the mixture is subject to extraction by a single or double threaded extracting machine, the extracted mixture is shaped by a T-shaped mold to form a continuous layer structure, the layer structure is applied on a fibrous textile and is subject to heat, and finally a textile permeated with plastic is formed after cooling.

Products of the textile permeated with plastic have many applications including automobile interior, flags, wallets, suitcases, handbags, clothes, shoes, etc. Stitching, adhesive, coating, and ultrasonic welding may be employed in the above manufacturing processes. For ultrasonic welding, it has the advantages of reduced manufacturing time, highly effective for applying plastic to textile, and quick shaping. For carrying out ultrasonic welding, any involved materials to be joined together are required to have polarity. Polarized molecules may quickly move due to the application of high-frequency ultrasonic acoustic vibrations. And in turn, molecules may generate friction to heat the material for softness or even melt. Some of the polarized materials are PU, PVC and TPU and they are widely used in the production of the textile permeated with plastic.

However, the textile with PU composition is easy to be hydrolysed. Hence, its molecular chains are subject to breakage when water is dropped onto the textile with PU composition. As a result, its surfaces may become yellow. This is not desired. Moreover, the textile with PU composition has a chain of organic units joined by urethane links. Hence, the textile with PU composition is difficult of being recycled.

The textile with TPU composition does not have a chain of organic units joined by plastic links and is more resistant to be hydrolysed in water. However, TPU is expensive than PU and this renders the textile with TPU composition to be less competitive in the market.

The textile with PVC composition is widely used. It is known that phthalates are mainly used as plasticizers (i.e., substances added to plastics to increase their flexibility, transparency, durability and longevity). Phthalates are used primarily to soften PVC. However, the addition of phthalates in PVC and heavy metal in the textile with PVC composition as stabilizer may generate dust and powder and cause pollution to the environment. Moreover, dioxins may occur as by-products in the incineration of chlorine-containing substances such as PVC. Thus, phthalates are being phased out of many products in the US, Canada, and European Union over health concerns.

The causes of the generation of dust, powder, and environmental pollution associated with the pressing process are due to the powder nature of PVC and the addition of a great amount of plasticizer. In another beneficial aspects, the pressing process is high in the number of products produced per time unit, easy control, and capable of producing products of uniform thickness. Hence, it is suitable for mass production with cost being reduced greatly.

There are textile products without PVC available. Further, they are added with TPO (thermoplastic olefin). However, pressing process for textile with TPO composition has the following drawbacks: High temperature and open manufacturing process. TPO is not stable in hot environment. TPO is prone to breakage and this can adversely lower the quality. Also, TPO is prone to sticking in the manufacturing process and this can adversely affect the shaping. Some attempts are tried by adding additives in TPO. However, TPO still suffers from the drawbacks of being weak when subjecting to heat, being prone to breakage by pulling when shaping, being difficult of joining to textile or other different materials, and being difficult of being employed in ultrasonic welding.

There is a type of PE (polyethylene) called LDPE (low-density PE) commercially available. Such LDPE is typically produced in a high pressure process. However, LDPE has the drawbacks of being high in molecular weight, having excessive number of branches, being low in melting point, and being prone to breakage due to many weak points.

There is a type of m-PE (metallocene PE) commercially available. Such m-PE has the following advantages: Molecules are uniform in size and concentrated. Branches formed by co-monomers are uniformly distributed. Collision strength is about four times higher than that of LDPE. However, its resistance to melting is low due to long chain branch (LCB).

There is another type of m-ULDPE (m-ultra LDPE) commercially available. The m-ULDPE is a plastic having urethane and butene or octene. Such m-ULDPE has the following advantages: Collision strength is about four times higher than that of LDPE. Increased resistance to melting is due to improvements of LCB. Molecules are concentrated and have a structure of LCB. It is suitable for pressing.

There is another plastic product with an intermediate layer of POE (polyolester) or POP (polyolefin plastomer) available. The product is produced by a number of repeated pressings. The products are widely used as brick panels with a foam-like intermediate layer. However, no lubrication materials are added to the product. Also, it is prone to sticking in the pressing process. Also, about 20-50% of calcium carbonate is added to polyolefin in the manufacturing process and this is not desired for the generation of foam. Further, problem of joining different materials is not solved. Thus, such technology has not found application in the manufacturing of textile permeated with plastic. Thus, the need for improvement still exists.

### SUMMARY OF THE INVENTION

It is therefore one object of the invention to provide a process of making a textile comprising dropping a predetermined amount of rubber copolymer in a reactor filled with a solvent including 90-100 wt % of toluene, 0-10 wt % of acetone, and 0-10 wt % of ethanol; adjusting conditions of the reactor to a predetermined range of temperature and a predetermined atmospheric pressure so as to reduce sizes of molecules of the rubber copolymer; adding water to the reactor to disperse the rubber copolymer in the solvent to make an aqueous solution with water-based rubber copolymer; and penetrating the water-based rubber copolymer through fibers of the textile for permanently attaching thereto.

The above and other objects, features and advantages of the invention will become apparent from the following detailed description taken with the accompanying drawings.

### BRIEF DESCRIPTION OF THE DRAWINGS

FIG. 1 is a flow chart of a process of applying a water-based rubber copolymer to a textile according to the invention.

### DETAILED DESCRIPTION OF THE INVENTION

The invention involves disposing rubber copolymer in a solvent to prepare an aqueous solution with rubber copolymer and the solution is next served as an applying material. In detail, the rubber copolymer is solved in a solvent in conditions of about 10-100° C. (preferably between about 20-35° C.) and one atmospheric pressure. Sizes of molecules of the rubber copolymer will be reduced. Next, water is added to the solvent to form an aqueous solution which is a high molecular aqueous solution. In short, a high molecular aqueous solution is made by dissolving high molecular solid in a solvent. The high molecular solid is rubber copolymer. Viscosity of the aqueous solution is about 150-30,000 cps (centipoises). The aqueous solution is next applied to a target textile (e.g., about 20-200 g/m²) or the textile is submerged in the aqueous solution. The rubber copolymer of the invention can be a rubber copolymer or a rubber emulsion copolymer having a grain size of about 5-40 μm.

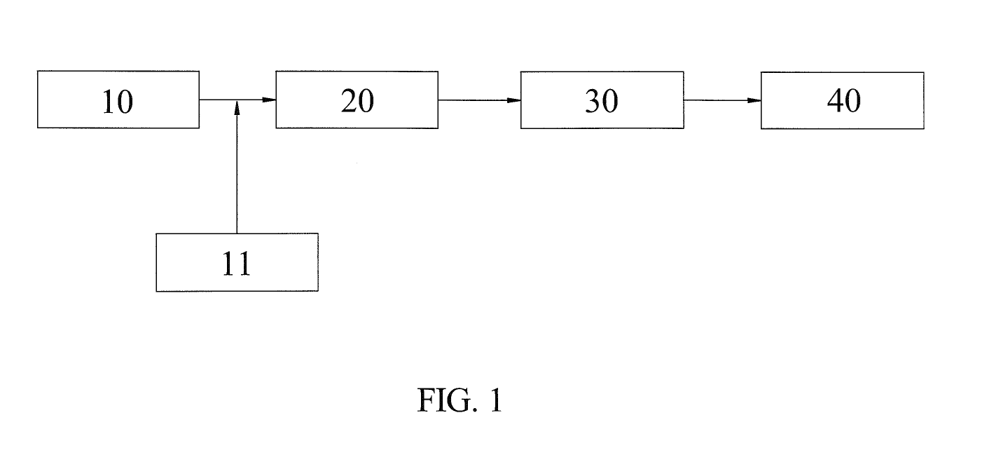

Referring to FIG. 1, a process of applying a water-based rubber copolymer to a textile in accordance with the invention is illustrated below. First, in step 10, dropping rubber copolymer in a reactor filled with solvent. The solvent has 90-100 wt % (weight percentage) of toluene, 0-10 wt % of acetone, and 0-10 wt % of ethanol. Sizes of molecules of the rubber copolymer will be reduced. Next in step 11, water is added to the solvent so that they can be reacted in conditions of 10-100° C. and one atmospheric pressure. In step 20, an aqueous solution is made at the end of the reaction. Next in step 30, adding thickening agents to the aqueous solution to increase its viscosity so that it may facilitate penetration through a target textile after applying thereto. The textile has tear strength of 5-30 lbf (lb force) in a warp direction and 3-30 lbf in a weft direction, abrasion of 200-1,000 rev (revolution), and seam slippage of 50-140 lbf. As a result, in step 40, a target textile with increased seam slippage, tear strength, and yarn bonding strength is obtained.

Following is a detailed description of a preferred embodiment of the invention so that above and other objects, features and advantages of the invention will become apparent.

a) Dropping rubber copolymer in a reactor filled with solvent. Water is next added to the solvent so that they can be reacted in conditions of 20-35° C. and one atmospheric pressure. An aqueous solution of 150 cps with initially dispersing rubber copolymer is made at the end of the reaction. Next, adding thickening agent to the aqueous solution to increase its viscosity to 18,000 cps. The solvent has 90-100 wt % of toluene, 0-10 wt % of acetone, and 0-10 wt % of ethanol. The solvent is further reacted with the rubber copolymer so that sizes of molecules of the rubber copolymer can be reduced. Next, add water to the aqueous solution with a weight ratio of the aqueous solution and water is about 2 to 1. As a result, an aqueous solution with dispersing rubber copolymer is made.

b) Applying the aqueous solution with water-based rubber copolymer to a target textile (e.g., 50 g/m²) so that it may facilitate penetration through the target textile after applying thereto. Alternatively, the textile may be submerged in the aqueous solution. Next, excessive water-based rubber copolymer is removed by pressing the textile.

The obtained textile is a textile permeated with plastic. Tear strength of the textile is next tested according to the specifications of ASTM-D-2261 (ASTM, American Society for Testing Material). Abrasion and seam slippage of the textile is also tested according to the specifications of ASTM-3884-92. Results of the tests are tabulated in Table I below.

TABLE I

| | | | | Seam |
|---|---|---|---|---|
| | Tear strength (lbf) | | Abrasion | slippage |
| | Warp direction | Weft direction | (rev) | (lbf) |
| Preferred | 13.3 | 12.1 | 850 | 110 |
| embodiment I | | | | |
| Comparative | 7.3 | 7.2 | 900 | 97.5 |
| embodiment I | | | | |

While the invention has been described in terms of preferred embodiments, those skilled in the art will recognize that the invention can be practiced with modifications within the spirit and scope of the appended claims.

What is claimed is:

1. A process of making a textile, comprising the steps of:
dropping a predetermined amount of rubber copolymer in a reactor filled with a solvent including 90-100 wt % of toluene, 0-10 wt % of acetone, and 0-10 wt % of ethanol;
adjusting conditions of the reactor to a predetermined range of temperature and a predetermined atmospheric pressure so as to reduce sizes of molecules of the rubber copolymer;
adding water to the reactor to disperse the rubber copolymer in the solvent to make an aqueous solution with dispersing rubber copolymer; and
penetrating the dispersing rubber copolymer through fibers of the textile for permanently attaching thereto.

2. The process of claim 1, wherein the penetration comprises applying the solution to the textile so as to penetrate the dispersing rubber copolymer through the fibers of the textile for permanently attaching thereto.

3. The process of claim 1, wherein the penetration comprises submerging the textile in the solution so as to penetrate the dispersing rubber copolymer through the fibers of the textile for permanently attaching thereto.

4. The process of claim 2, wherein the application comprises applying the solution to the textile in a weight of 20-200 g/m².

5. The process of claim 1, further comprising adding thickening agents to the solution to increase viscosity of the solution.

6. The process of claim 5, wherein the viscosity of the solution is 150-30,000 cps.

7. The process of claim 1, wherein the predetermined range of temperature is between 10-100° C. and the predetermined atmospheric pressure is 1 atmospheric pressure.

8. The process of claim 1, wherein the predetermined range of temperature is between 20-35° C.

9. The process of claim 1, wherein the rubber copolymer is rubber emulsion copolymer.

10. The process of claim 1, wherein the rubber copolymer is a rubber copolymer having a grain size of 5-40 μm.

11. The process of claim 1, wherein the addition comprises adding water to the solution with a weight ratio of the solution and the water is 2 to 1 to make an aqueous solution with dispersing rubber copolymer.
